(19) United States
(12) Patent Application Publication
(10) Pub. No.: US 2002/0035875 A1
(43) Pub. Date: Mar. 28, 2002

(54) Bending moment sensor

(76) Inventors: Zlatko Penzar, Frankfurt (DE); Jurgen Irion, Wittingen (DE); Wolfgang Porth, Frankfurt (DE); Andrea Rassler, Steinbach (DE)

Correspondence Address: Richard A. Speer, MAYER, BROWN & PLATT, P.O. Box 2828, Chicago, IL, 60690-2828, US

(21) Appl. No.: 09/954,730

(22) Filed: Sep. 18, 2001

(30) Foreign Application Priority Data
Sep. 19, 2000 (EP) DE 200 16 329.9
Jul. 17, 2001 (EP) DE 101 35 686.2

(51) Int. Cl. G01N 3/20

(52) U.S. Cl. 73/849

(57) ABSTRACT

The invention relates to a bending moment sensor with a bridge circuit having strain-sensitive resistors, the strain-sensitive resistors being arranged immediately on a component on which bending forces act directly without intermediate support, it being possible upon bending of the component to tap at the bridge circuit an electric signal corresponding to the strain of the thick-film resistors.

In a bending moment sensor in which the generation of an error-free bridge signal is ensured given a varying bending load, the strain-sensitive resistors (R1, R2, R3, R4) are arranged on the component (1) like a circle, resistors of a bridge arm (R1, R2; R3, R4) each being arranged diagonally relative to one another in a position (r₀) in which the change in resistance of each resistor (R1, R2, R3, R4) under bending adopts equal absolute values, and the output signal (U₀) that can be tapped at the bridge circuit depends only on the bending moment.

The invention relates to a bending moment sensor with a bridge circuit having strain-sensitive resistors, the strain-sensitive resistors being arranged immediately on a component on which bending forces act directly without intermediate support, it being possible upon bending of the component to tap at the bridge circuit an electric signal corresponding to the strain of the thick-film resistors.

Bending moment sensors known per se have bridge circuits which are formed with the aid of strain-sensitive thick-film resistors which are arranged immediately on a component to be loaded by bending. The resistors of the bridge circuits are arranged outside the direction of extent of a phase of the component that is neutral for bending load, and are at a prescribed distance and a prescribed angle from said phase.

Upon the application of spatially varying bending moments, however, different changes in resistance and, additionally, torsional influences occur in the case of the resistors and falsify the measurement result.

It is therefore the object of the invention to specify a bending moment sensor in which the generation of an error-free bridge signal is ensured in the case of a varying bending load.

The object is achieved according to the invention by virtue of the fact that the strain-sensitive resistors are arranged on the component like a circle, resistors of each bridge arm each being arranged diagonally relative to one another in a position in which the change in resistance under bending load adopts equal absolute values, and the output signal that can be tapped at the bridge circuit depends only on the bending moment.

The invention has the advantage that the signal changes caused by different strain values in the direction of current application of the resistors need not be compensated in circuitry, but are corrected solely by the placement of the resistors.

In a development, the strain-sensitive resistors of the bridge arm are arranged outside, and in the edge region of, a cutout running on the surface of the component, and in a fashion embracing said cutout.

This has the advantage that the signal response of the bending moment sensor can be enhanced in a simple way. Because of the cutout, the mechanical stresses acting on the support element are superimposed on one another, the strain in the main directions (longitudinal, transverse) having unequal absolute values, as a result of which the tapped measuring signal at the bridge circuit can be increased in a simple way.

Load-induced changes in the resistance values can be corrected in a particularly simple way when the component has radial indentations in its edge region, and the cutout has radial regions, in each case one radial indentation and one radial region of a cutout being assigned to a resistor which is arranged on a connecting line of the first radius of the indentation and a second radius of the cutout.

If the cutout is of circular design, each resistor is arranged radially with approximately equal angular spacings about the cutout. That is to say, the resistors are located at the same spacing from the middle of the bore.

The signal response of the sensor is easily enhanced by the cutout without complex changes to the shaft geometry. Such a sensor is suitable for mass production, since it can be fabricated favorably in terms of cost and time.

The resistors arranged on the metal component are as advantageously designed as thick-film resistors, the sensitivity of the resistance pastes used to produce the resistors differing with respect to longitudinal and transverse strain. An enhancement of the signal response of the sensor is also achieved thereby.

In a development of the invention, the thick-film resistors are arranged in one plane in order to measure the bending. However, it is also possible for the thick-film resistors to be arranged in one or more planes.

It is also advantageously possible to use two bridge circuits, the resistors of the first bridge circuit being arranged in a position r₁<r₀ and the resistors of the second bridge circuit being arranged in a position r₂>r₀, the positions r₁ and r₂ having the same difference relative to the position r₀ in terms of absolute value.

The invention permits numerous embodiments. One of these is to be explained in more detail with the aid of the figures illustrated in the drawing, in which:

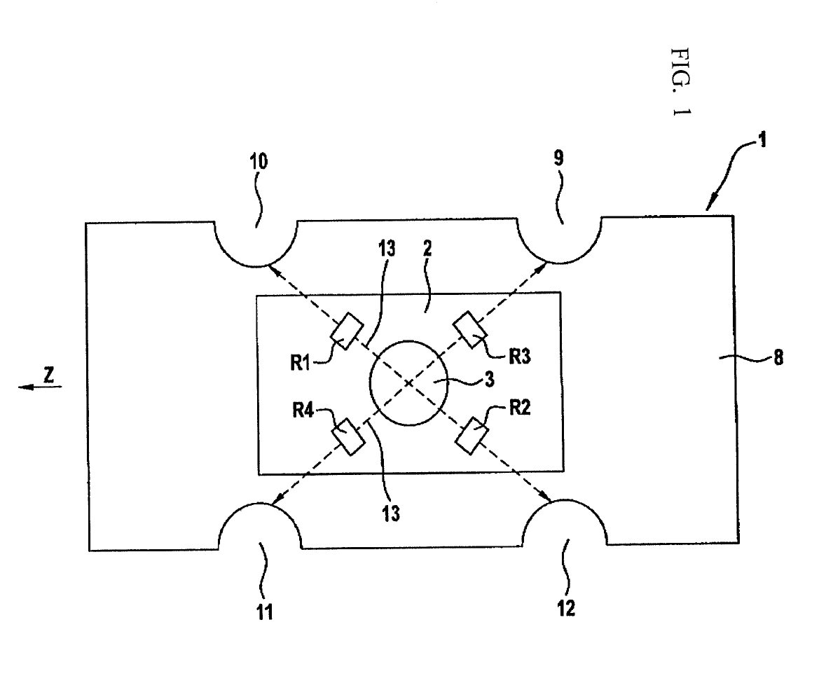

FIG. 1 shows a plan view of a component according to the invention that is to be loaded by bending,

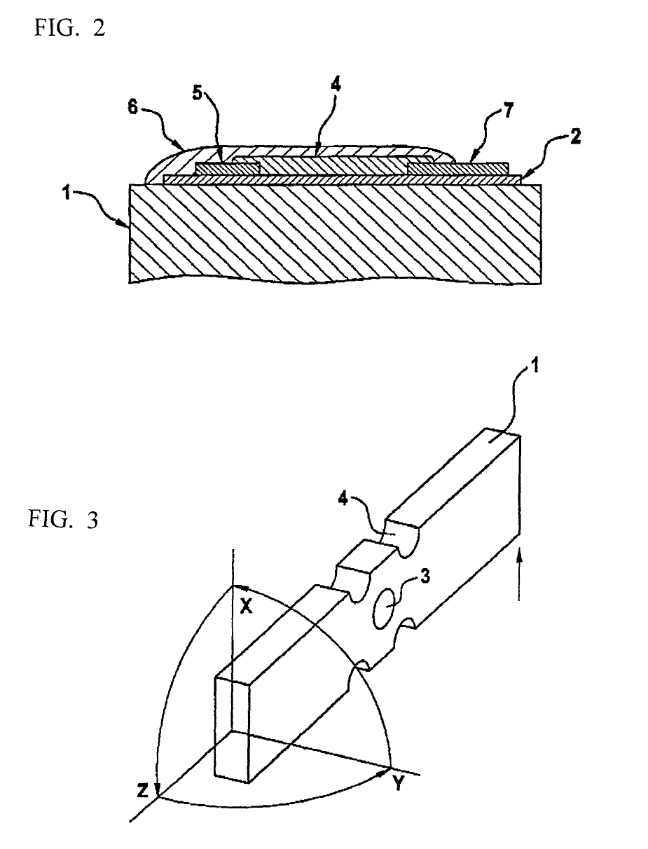

FIG. 2 shows an arrangement of the strain-sensitive resistor on the component according to FIG. 1,

FIG. 3 shows a mechanical loading of the component, and

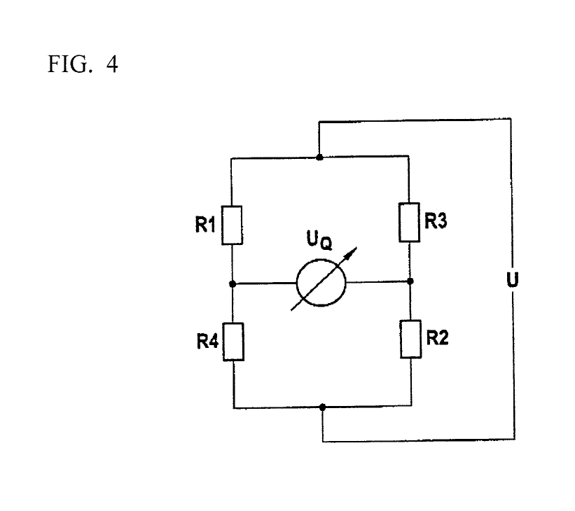

FIG. 4 shows the voltage variation in the bridge circuit.

Identical features are marked with identical reference symbols.

A bending moment sensor is illustrated in FIG. 1. Identically constructed thick-film resistors R1, R2, R3, R4 are arranged on a shaft 1 which is to be loaded by bending, consists of steel or a steel alloy and is cuboid. The resistors R1, R2, R3, R4 are combined to form a bridge circuit in accordance with FIG. 4.

The resistance bridge is arranged in its entire extent on a dielectric 2 which rest directly on the component 1 without intermediate support. A section through an strain-sensitive resistor R1 is illustrated in FIG. 2.

As may be seen from FIG. 2, electric conductor tracks 5 which are formed by a conductor track layer are located on the dielectric 2. An electric resistance layer 9 which forms the resistor R1, R2, R3 or R4 designed as a strain gauge extends between these conductor tracks 5. The closure is formed by a passivation layer 6, which leaves uncovered only that part of at least one conductor track 5 serving as contact surface 7, and serves to make electric contact with the resistor R1.

The strain gauge described is produced immediately on the substrate 1 using thick-film technology.

In order to produce an intimate connection between the dielectric 2 and the component 1, the dielectric 2 is applied to the shaft 1 by means of a non-conducting paste using printing technology. In this case, the paste contains a fritted glass filter, which can be fused at low temperature, as the material of the shaft 1. After application of the paste, a conducting layer is applied, likewise using screen printing technology, and forms the conductor track 5 and the contact surface 7 on which, in turn, the structured resistance layer 4 forming the resistors R1, R2, R3, R4 is arranged. The shaft 1 thus prepared is subjected to heat treatment in a high-temperature process at a temperature of approximately 750 to 900° C. The glass layer is sintered in the process with the surface of the steel of the shaft 1. During this sintering, oxide bridges are formed between the dielectric 2 and the shaft 1 and ensure a permanent connection between the shaft 1 and dielectric 2, resulting in a deeply intimate connection between the two.

As may be seen from FIG. 1, the shaft 1 has a rectangular surface 8, a circular opening 3 which completely penetrates the shaft 1 being formed in the center.

The edge of the component 1 has respectively on both sides in its longitudinal extent two semicircular edge cutouts 9, 10 and 11, 12, respectively, the cutouts 10 and 11 as well as 9 and 12 being arranged opposite one another. The radii of the edge cutouts 9, 10, 11, 12 correspond approximately to the radius of the opening 3.

The strain gauges R1, R2, R3, R4 are arranged in each case on a line 13 proceeding from the center point of the opening 3, the line 13 constituting the imaginary connection between the radius of an edge cutout 9, 10, 11, 12 and the radius of the opening 3. Because of the opening 3 and the edge cutouts 9, 10, 11, 12, in the case of a bending load along an imaginary center line Z, two main strains with different absolute values occur on the surface of the shaft 1, said main strains corresponding from the point of view of the respective thick-film resistor R1 to R4 to a longitudinal strain and a transverse strain.

As may be gathered from FIG. 3, in this case the shaft 1 is considered as a bending beam which is firmly clamped at one end. Proceeding therefrom, the X-axis illustrated in FIG. 3 in this case forms a flexurally soft axis, while the axis pointing in the Y-direction is a flexurally stiff axis. The shaft axis Z corresponds in this case simultaneously to the phase of the shaft 1 neutral with regard to the bending moment. In accordance with FIG. 1, the resistors R1 and R2 and, respectively, R3 and R4, which form a bridge arm, are arranged on both sides relative to the neutral phase. Since all the resistors R1 to R4 are positioned with the same radial spacing about the cutout 3, they all have the same spacing in terms of absolute value in relation to the neutral phase, but differ from one another in their angular spacing relative to the neutral phase.

In accordance with FIG. 4, in this case the resistors R1, R2, R3, R4 are wired up electrically to form a bridge circuit.

The resistors behave differently in the case of spatially varying bending load, there being a position relative to the center point of the opening 3 for which the change in resistance is equal in all the resistors R1, R2, R3, R4. This holds for any arbitrary bending load about the flexurally stiff axis.

The result for a general bending load (moment and moment gradient) about the flexurally stiff axis (Y-axis) is that the changes in resistance ΔR₁ and ΔR₃ reach equal values given the distance r₀ of the resistors R1 and R3 from the center of the opening 3.

It holds for the changes in resistance ΔR2 and ΔR4 that:

ΔR₂=ΔR₃ and ΔR₄=−ΔR₁ (1)

In the case of wiring up in accordance with FIG. 4, the result is a bridge signal

U_{Q}=U·1/4R(ΔR₁+ΔR₃−ΔR₂−ΔR₄) (2)

The result for the position r₀ is

ΔR₁=ΔR₃ (3)

Consequently, taking account of FIG. 1, this yields

ΔR₂=ΔR₄ (4),

a bridge signal of

ΔU_{Q}=U·A_{S}·M_{Y}·(Z_{c})

resulting from the formula 2.

Here, Aₛ is a constant factor which depends on the exact sensor dimensions, the sensor material and the resistance properties.

M_{Y} (Z_{c}) is the value of the bending moment about the flexurally stiff axis (Y-axis in FIG. 1).

This circuit is simultaneously insensitive to torsion, since it holds under torsion for reasons of symmetry that

ΔR₁=ΔR₂ and ΔR₃=ΔR₄

as a result of which the bridge signal U_{Q}=0 is yielded in formula 2.

On the basis of this arrangement and signal evaluation, in the position r=r₀, this sensor is compensated in terms of torsion and transverse force for bending moments about the flexurally stiff axis. Moreover, the sensor is insensitive to bending about the torsionally soft axis.

A similar picture results in the case of an arbitrary spatially varying bending load about the flexurally soft axis (X-axis). It holds in this case that

ΔR₁=ΔR₄ and ΔR₂=ΔR₃

for each radial position r. The result here, once again, is U_{Q}=0 for the bridge signal.

A plurality of such bridge circuits can be juxtaposed at will next to one another on such a sensor. Bending measurements can also be performed in this case when the bridge resistors are arranged in one or in a plurality of planes. They lead to the same torsion-compensated result.

A reliable measurement can also be achieved when two bridge circuits are present, the resistors of one bridge being arranged in positions r>r₀, and the resistors of the other bridge being arranged in positions r<r₀, the errors induced by torsion and transverse force respectively having different signs, and the absolute values of the errors being equal.

1. A bending moment sensor comprising a bridge circuit having strain-sensitive resistors, the strain-sensitive resistors being arranged immediately on a metallic component on which bending forces act directly without intermediate support, it being possible upon bending of the component to tap at the bridge circuit an electric signal corresponding to the strain of the thick-film resistors, wherein the strain-sensitive resistors (R1, R2, R3, R4) are arranged on the component (1) like a circle, resistors of a bridge arm (R1, R2; R3, R4) each being arranged diagonally relative to one another in a position (r₀) in which the change in resistance of each resistor (R1, R2, R3, R4) under bending adopts equal absolute values, and the output signal (U_{Q}) that can be tapped at the bridge circuit depends only on the bending moment.

2. The bending moment sensor as claimed in claim 1, wherein the strain-sensitive resistors (R1, R2, R3, R4) of the bridge arm are arranged outside of, and embracing the cutout (3) running on the surface (8) of the component (1).

3. The bending moment sensor as claimed in claim 2, wherein the component (1) has in its edge region radial indentations (9, 10, 11, 12), and the cutout (3) has radial regions, in each case one radial indentation (9, 10, 11, 12) and one radial region of a cutout (3) being assigned to a resistor (R1, R2, R3, R4) which is arranged on a connecting line (13) of the first radius of the indentation (9, 10, 11, 12) and a second radius of the cutout (3).

4. The bending moment sensor as claimed in claim 3, wherein the cutout (3) is of circular design, each resistor (R1, R2, R3, R4) being arranged radially with approximately equal angular spacings about the cutout (3) and perpendicular to the connecting line (13) in its longitudinal extent.

5. The bending moment sensor as claimed in one of the preceding claims, wherein the resistors (R1, R2, R3, R4) are arranged on the plane surface (8) of the component (1) consisting of metal and having a rectangular cross section.

6. The bending moment sensor as claimed in claim 5, wherein the resistors (R1, R2, R3, R4) are designed as thick-film resistors, the sensitivity of the resistance pastes used to produce the resistors differing with respect to longitudinal and transverse strain.

7. The bending moment sensor as claimed in claim 5 or 6, wherein the thick-film resistors (R1, R2, R3, R4) are arranged in one plane in order to measure the bending.

8. The bending moment sensor as claimed in claim 5 or 6, wherein the thick-film resistors (R1, R2, R3, R4) are arranged in two or more planes in order to measure the bending.

9. The bending moment sensor as claimed in claim 1, wherein two bridge circuits are present, the resistors of the first bridge circuit being arranged in a position r₁<r₀ and the resistors of the second bridge circuit being arranged in a position r₂>r₀, the positions r₁ and r₂ having the same difference relative to the position r₀ in terms of absolute value.
